(19) United States
(12) Patent Application Publication
(10) Pub. No.: US 2010/0263664 A1
(43) Pub. Date: Oct. 21, 2010

(54) PORTABLE OXYGEN DELIVERY DEVICE AND METHOD FOR DELIVERING OXYGEN TO A MOBILE USER

(75) Inventors: Zoran Radivojevic, Cambridge (GB); Jarkko Saunamaki, Vantaa (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/747,383

(22) PCT Filed: Dec. 10, 2007
(86) PCT No.: PCT/EP2007/010737

§ 371 Date: Jun. 10, 2010

(51) Int. Cl. A62B 7/00

(52) U.S. Cl. 128/202.26

(57) ABSTRACT

A portable oxygen delivery device for increasing the oxygen content in the air inhaled by a user. The device includes solar cells that harvests energy over longer period of time and power instantaneously an electrolysis unit on user-demand for purpose of oxygen refreshment. The oxygen gas produced by the electrolysis unit is conveyed by tubing to an area in the vicinity of the users mouth and nose. The solar cells and the electrolysis unit are integrated in a garment worn by the user.

### FIELD OF THE INVENTION

The present invention relates to a portable device for increasing the oxygen content of the air inhaled by a user, in particular a user and a device that provides high operational autonomy. Further, the invention relates to a method of increasing the oxygen content of the air inhaled by a user.

### BACKGROUND OF THE INVENTION

Increased oxygen supply provides for improved well-being of persons in certain circumstances. Modern lifestyle keeps many people from sufficient access to fresh air. In particular in highly urbanized areas in which people mainly stay inside may lead to oxygen deficiency for those concerned. The well-being of these people can be improved by increasing the amount of oxygen in the air that they inhale.

Portable oxygen dispensing systems are known, for example in the form of compressed enriched air bottles. However, these bottles are depleted relatively fast, which leads to a substantially reduced operational autonomy and leads to substantial operational costs.

### DISCLOSURE OF THE INVENTION

On this background, it is an object of the present invention to provide portable oxygen delivery device that overcomes or at least reduces the problems indicated above.

In this invention it is proposed to realize autonomous portable oxygen delivery system by utilizing energy of the sunlight illumination (via solar cells—SC) and natural water to provide oxygen enrichment in the breathing air.

This object is achieved by providing a portable oxygen delivery device for increasing the oxygen content in the air inhaled by a user, the device comprising an energy source coupled to an electrolysis unit that is configured to split water into oxygen gas and hydrogen gas, an oxygen dispensing conduit coupled to the electrolysis unit, the conduit being configured to transport the oxygen produced to an area near the users nose and mouth and the conduit being configured to release the oxygen produced in the area near the users nose and mouth.

Thus, a portable oxygen delivery device is provided that is substantially completely autonomous, since sunlight and water are can be freely found almost everywhere.

The energy source may comprise at least one solar cell.

The solar cells may be integrated into a garment. Thus, the oxygen delivery device is comfortable to carry.

Preferably, the solar cells are flexible solar cells. Thus, the device is easily integrated in a garment.

The garment can be a jacket, a vest, a cap a belt or a backpack.

The electrolysis unit may comprise a water container with two separate gas receiving chambers.

Preferably, each gas receiving chamber has at least one of at least two of the electrodes of the electrolysis unit.

The container can be an exchangeable cartridge. Thus, the water container is easily exchanged by user when necessary.

The container or cartridge can be of a type that is refillable. Thus, the water container is easily refilled by user when necessary.

Preferably, the electrolysis unit is integrated into a garment, so that it is easy to carry.

The solar cells and the electrolysis unit may further comprise a rechargeable battery or capacitor and the solar cells and the electrolysis unit can be connected to the battery or capacitor. Thus, the maximum oxygen production capacity is dependent on the maximum power output of the rechargeable battery or capacitor and not limited to the instantaneous power output of the solar cells, given that the battery or capacitor is charged.

The solar cells may be substantially permanently connected to the capacitor or battery for charging the battery or capacitor. Thus, the battery or capacitor is charged anytime light is available to the solar cells.

The electrolysis unit can be selectively connectable to the battery or capacitor. Thus, the user can activate and deactivate the oxygen production in accordance with his/her needs.

The device may further comprise an electrical connector for allowing the electrolysis unit and/or battery or capacitor to be connected to an external source of electrical power. Thus, the battery can be recharged quickly if necessary and/or the power for the electrolysis unit is supplied by an external power source.

The dispensing conduit may be connected to the outlet of the gas receiving chamber that contains one of the anodes of the electrodes.

A filter can be disposed at the outlet, preferably a filter capable of withholding water droplets. Thus, it is avoided that water is transported through the dispensing conduit.

The device may further comprise a gas flow regulator adapted to regulate the flow of oxygen towards the user. Thus, the user can control the amount of oxygen delivered in accordance with his/her needs.

The device may further comprise an oxygen dispensing arm in the upstream portion of the dispensing conduit. Thus the delivery to the correct area in the vicinity of the user's mouth and nose can be achieved.

The oxygen dispensing arm can be integrated into a body garment. Thus, the oxygen dispensing arm is easily carried.

The oxygen dispensing arm can be integrated into a cap or spectacles.

The dispensing conduit may include flexible tubing between the electrolysis unit and the oxygen dispensing arm.

The device may further comprise a hydrogen gas release vent coupled to the gas receiving chamber that contains one of the cathodes of the electrodes.

The object above is also achieved by providing a method for increasing the oxygen content in the air inhaled by a user, the method comprising providing a portable electrolysis device that is configured to split water into oxygen gas and hydrogen gas, collecting the oxygen gas and transporting it towards an area in the vicinity of the users mouth and nose, and delivering the oxygen gas in the vicinity of the users mouth and nose.

The portable electrolysis device may be solar cell driven.

Preferably, electrolysis device includes a rechargeable battery or capacitor, and the method may further comprise the step of charging the rechargeable battery or capacitor with the solar cells also when electrolysis and device is not active.

The electrolysis device may comprise a refillable water container, and the method may further comprise refilling the water container.

The electrolysis device may comprise a user exchangeable water cartridge, and the method may further comprise exchanging the user exchangeable water cartridge.

The object above can also be obtained by a providing mobile device comprising a controller, the mobile device being provided with an interface for connecting to a portable oxygen delivery device and the mobile device being configured for controlling the operation of a portable oxygen delivery device.

The mobile device may be configured to start and stop the oxygen production process in the portable oxygen delivery device.

The mobile device may be configured to start and stop the stop the oxygen production process in accordance with the status of the mobile device.

The mobile device may be provided with sensors for providing real time measurements, and configured to start and stop the oxygen production process in accordance with the result of the real time measurements.

The real time measurements may include one or more of place, ambient air quality, ambient air pollution level, ambient air oxygen level, temperature, ambient air pressure, altitude, user heart rate and user breathing rate.

The status of the mobile device may change through the receipt of a message or command string from a remote service or device.

The message or command string may be received from a remote device or a remote service.

The mobile device may be a communication device.

The object above may also be achieved by providing a use of a mobile electronic device that comprises a rechargeable battery to power a portable oxygen delivery device.

The object above may also be achieved by providing a use of a mobile electronic device to control the operation of a portable oxygen delivery device.

Further objects, features, advantages and properties of the mobile battery charging device and method of according to the invention will become apparent from the detailed description.

### BRIEF DESCRIPTION OF THE DRAWINGS

In the following detailed portion of the present description, the invention will be explained in more detail with reference to the exemplary embodiments shown in the drawings, in which:

FIG. 1 is a block diagram illustrating the general architecture of a portable oxygen delivery device according to an embodiment of the invention,

FIG. 2 is perspective view of a portable oxygen delivery device according to an embodiment of the invention,

FIG. 3 is a cross-sectional view of the portable oxygen delivery device according to FIG. 2,

FIG. 4 is a perspective view of a portion of a portable oxygen delivery device according to an embodiment of the invention,

FIG. 5 is a perspective front view of another portion of the portable oxygen delivery device according to FIG. 4,

FIG. 6 is a perspective rear view of another portion of the portable oxygen delivery device according to FIG. 4,

FIG. 7 illustrates a detail of the oxygen delivery device according to FIGS. 5 and 6,

FIG. 8 illustrates a flowchart of a method according to the invention,

FIG. 9 is a front view of a mobile device according to an embodiment of the invention, and

FIG. 10 is a diagrammatic block diagram of the mobile device according to FIG. 9.

### DETAILED DESCRIPTION OF PREFERRED EMBODIMENTS

In the following detailed description, the autonomous portable oxygen delivery device according to the invention will be described by the preferred embodiments.

The basic design of the portable oxygen delivery device includes:
Flexible (or rigid) solar cells integrated into portable forms such as cap, vest, jacket or a strip like garments,
A water container or cartridge (exchangeable) with two separate chambers (for Oxygen/Hydrogen generation) and built-in electrodes (the electrode may be formed by interior coating of the chamber surface by carbon or metal),
An oxygen dispersing arm for delivery of the produced under nose/mouth.

According to embodiments the portable oxygen delivery device may also include an alternative electric connector to/from an external electronic device, such as to the battery of a mobile phone, and
A gas flow regulator.

Electrolysis of water is an electrolytic process which decomposes water into oxygen (O2) and hydrogen (H2) gas with the aid of an electric current. The electrolysis cell consists of two electrodes (usually carbon conductive traces or an inert metal layer) connected to opposite poles of a source of direct current. The energy efficiency of the electrolysis is relatively high (approximately 95%).

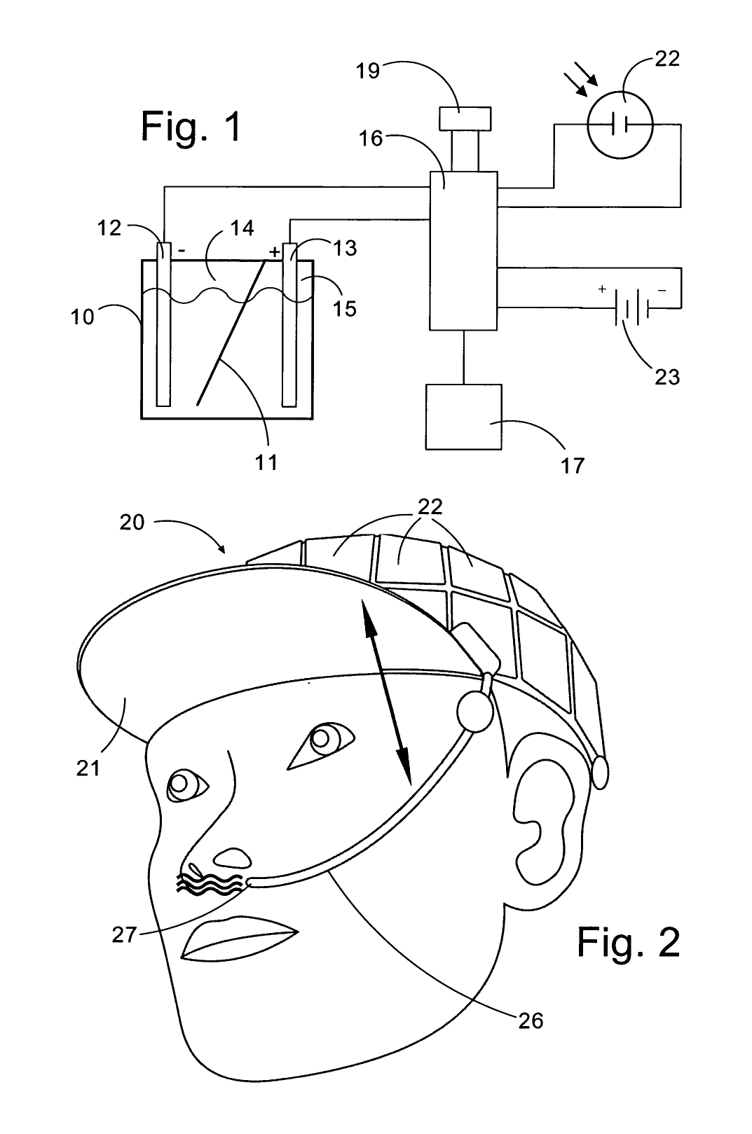

FIG. 1 is a block diagram of the portable oxygen delivery device according to an embodiment of the invention. The device includes a water container 10 but is at least partially filled with water and divided by a separation wall 11 into two chambers. An anode 12 is received in chamber 14 and at least partially immersed in the water in chamber 14. The upper part of the chamber 14 receives that hydrogen gas that is produced during the electrolysis process. A cathode 13 is received in chamber 15 and at least partially immersed in the water in chamber 15. The upper part of chamber 15 receives the oxygen gas that is produced during the electrolysis process.

The anode 12 and the cathode 13 are electrically connected to one more solar cells 22 and a rechargeable battery or capacitor 23 via a controller 16. The controller 16 controls the flow of electricity (direct current) from the solar cells 22 to the rechargeable battery and from the battery 23 to the anode 12 and cathode 13, respectively. The controller 16 is configured to use the electricity produced by the solar cells to charge the battery at any time, i.e. the solar cells charged the rechargeable battery 23 per default. The activation of the electrolysis process is controlled by the controller 16 by selectively connecting and disconnecting the electrodes 12,13 to the rechargeable battery 23. The controller receives its instructions from the user via a user interface 17. The user interface 17 may consist of a keypad, switches, or any other user input means.

The controller 16 is also connected to an external electric connector 19 that is configured to connect to an external source of electrical power, e.g. the battery of a mobile phone (not shown). The external electric connector 19 may in an embodiment also include an interface for interfacing with a mobile device that takes over the control of the oxygen delivery device. The controller 16 is configured to use the external electrical power for recharging and the rechargeable battery 23 and/or for directly powering the electrolysis process. Battery operation allows oxygen delivery when no or little sunlight is available.

Different type of Solar Cells have been developed over past decades, like silicon or relatively new organic dye sensitized solar cells on flexible/transparent substrates. Inherent conversion efficiency of today's ordinary solar cells is in range of 10-20%. The solar cell technology is rapidly developing. There are very strong indications that conversion efficiency will be further improved to higher levels as 35-50%. The power of sunlight at sea level is about 1200 W/m2. Taking into account ordinary solar cell conversion efficiency yields in a solar cell area of about S1=10×10 cm (100 cm2) capable to generate approximately 2 W of electric power.

A relatively small amount of oxygen is required to provide noticeably better air quality by enhancing oxygen concentration in breathable air. Approximately 50 liters of oxygen gas per hour is consumed by an ordinary adult. An improvement in oxygen concentration by 10% can already make positive impact. This means that approximately 5 liter of pure oxygen per hour substantially improves a person's psychophysical condition.

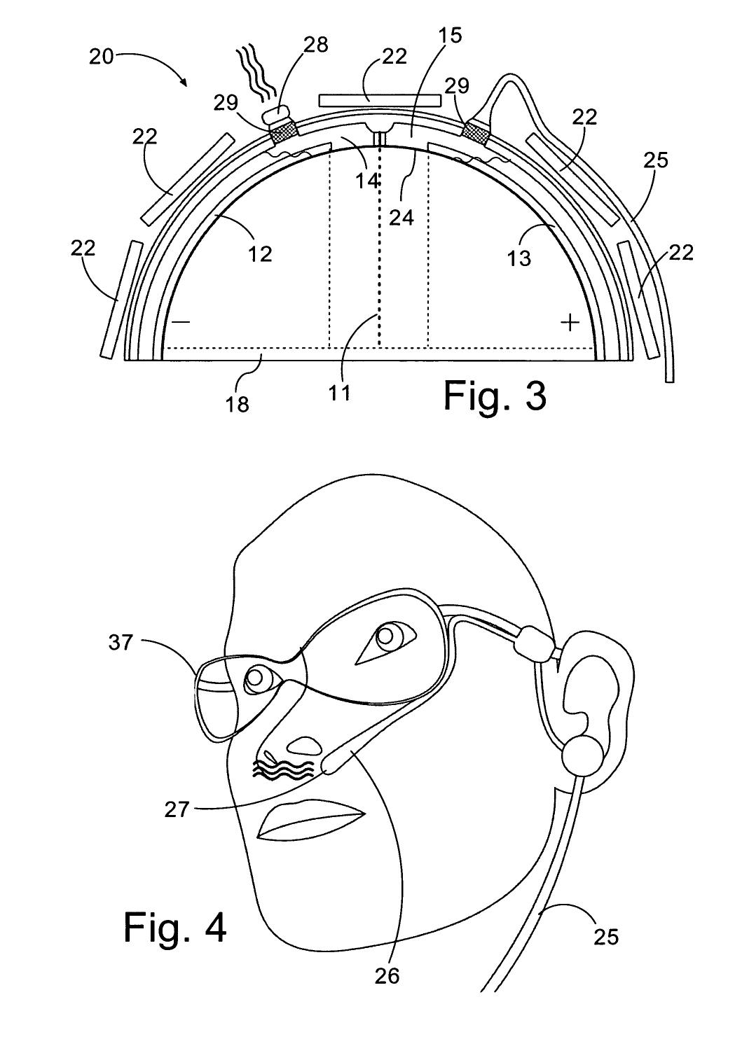

FIGS. 2 and 3 illustrate an embodiment of the portable auction delivery device that is integral with a cap 20 that can be worn by a user. The power generating solar cells 22 (in flexible form or as a set of rigid cells) are placed on top of the cap 20 and sunshade 21 (total surface covered by solar cells is approximately 1000 cm2). Such cap concept is capable to generate 10-20% oxygen enrichment in the breathable air in front of the user nose/mouth.

In the overall structure of the cap 20; there are two basic parts: the cover made of the solar cells 20 and the internal layer that forms a water containing cartridge. Below the solar cell layer there is exchangeable (and refillable) cartridge 24 at least partially filled with water. The cartridge 24 is realized by using soft rubber/polymer like materials which at the same time provide a soft coupling to the user head. The cartridge 24 is physically divided into two separated chambers (oxygen gas chamber 15 and hydrogen gas chamber 14) by a separation wall 11 for oxygen and hydrogen generation, respectively. At the bottom of the cap a ring shaped channel 18 connects the chambers 12 and 13. At the inner side of the cartridge there is a conductive surface coating (e.g. carbon or metallic coating) which serves as electrode surface 12,13. The conductive surface can cover the complete interior surface of the cartridge (to maximize efficiency) but it is physically separated providing two separated electrodes (anode 12/cathode 13).

When the cartridge 24 (and thus both chambers 14,15) is filled with water, the electrodes 12, 13 powered by electric current from illuminated solar cells (or from a not shown battery), the electrolysis process is started. Above the anode (+) oxygen 12 is generated which is collected and exhausted at an outlet nozzle on top of the oxygen receiving chamber 15.

At the chamber outlet there is a GoreTex® layer/filter 29 which prevents water from spilling into a flexible tubing that leads the oxygen gas towards the user. The GoreTex® filter 29 stops water but allows the oxygen gas to flow outside. Instead of Gore-Tex® another type of a gas permeable filter capable of withholding water droplets can be used.

The oxygen gas is further transported by the flexible tubing 25 towards a dispersing arm 26 where there is a gas flow regulator (not shown) allowing in the user to adjust the flow rate. The dispersing arm 26 is integrated into the cap also and can be clipped up/down (depending on usage). The oxygen dispensing arm 26 ends in vicinity of the user's nose and mouth thereby enriching the breathing air just in front of the user's nose and mouth. The dispensing arm 26 is designed to fit firmly on the head's cap to allow for physical activities (moving, walking, running, etc). In parallel with oxygen gas certain amount of hydrogen gas is generated in the key hydrogen receiving chamber 14 that receives the cathode. The hydrogen gas is released into the atmosphere through a vent 28 that is also provided with a Gore-Tex® filter 29 or other a gas permeable filter material capable of withholding water droplets.

Both the H2 vent 28 and the O2 outlet connections can be detached/attached providing possibility to access both electrolysis chambers for water refill.

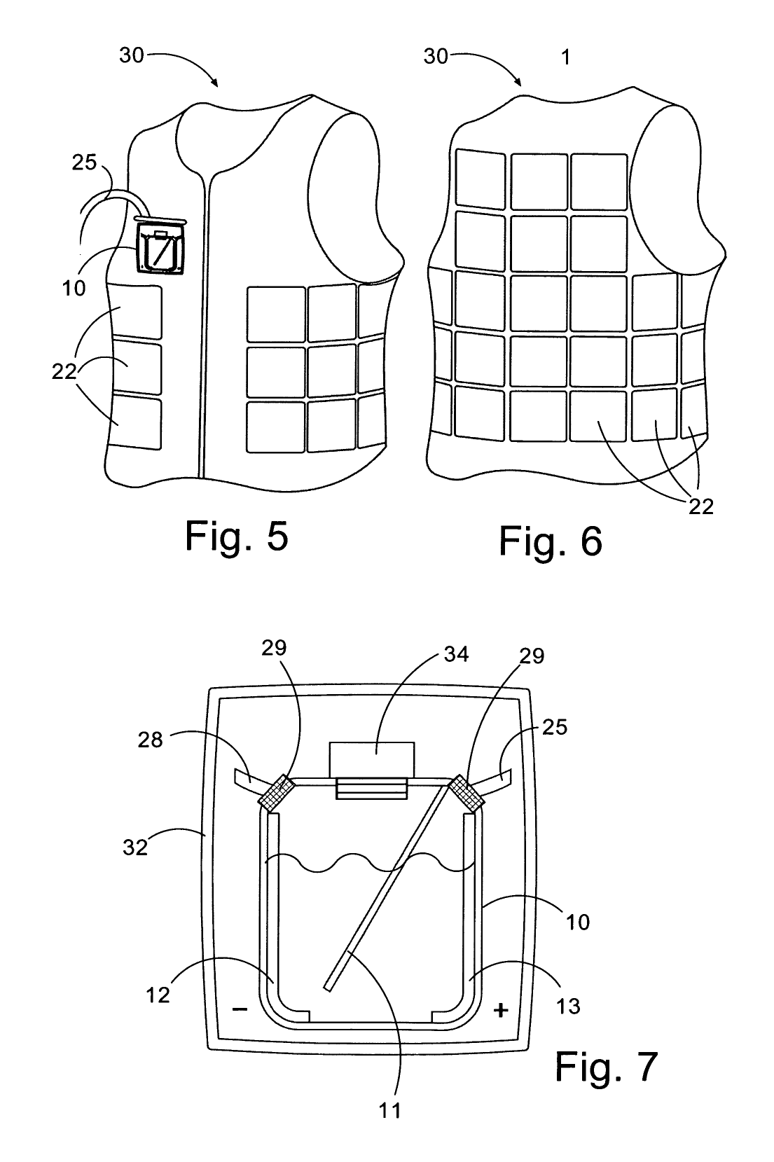

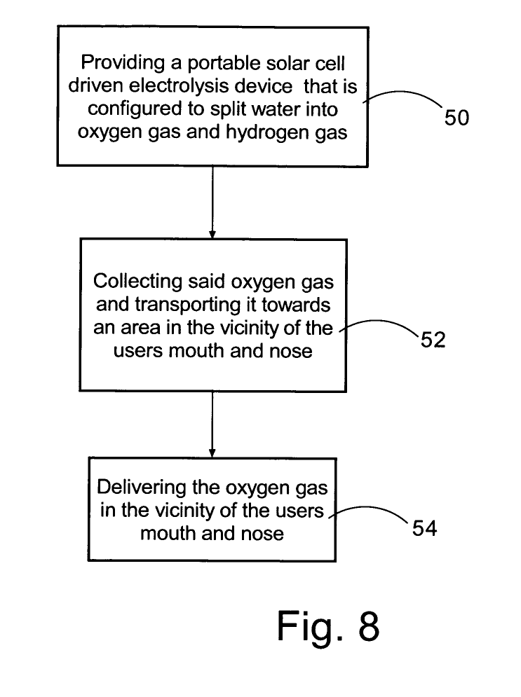

FIGS. 4 to 7 illustrate another embodiment of the oxygen delivery device according to the invention. In this embodiment the oxygen delivery device is realized in the form of a vest 30 which takes advantage of a larger available surface on the vest. A solar cell covered vest can provide a sufficient amount of electrical power for a higher level of oxygen generation. The available service on the vest can be large, approximately 5000 cm² (or even larger like solar cell coat). The exchangeable water cartridge 10 is realized in the form of a vest pocket 32. The cartridge 10 has a lid 34 that allows the user to refill the cartridge 10 with water. Alternatively, user can exchange the cartridge 10 after use. The cartridge 10 is kept into the vest pocket and can be exchanged or filled (depending on user situation and conditions).

The produced oxygen gas is transported via flexible tubing 25 to the oxygen dispensing arm 26. In this embodiment the oxygen dispensing arm 26 is an integral part of a pair of glasses or spectacles 37. The pair of glasses or spectacles 37 could be a pair of sunglasses or other glasses that do not have any optical lens effect.

FIG. 7 illustrates a flow chart of the method according to an embodiment of the invention. In the first step 50 a portable solar driven electrolysis device is provided. The electrodes device is configured to split water into oxygen gas and hydrogen gas. In the next step 52 the oxygen gas is collected and transported towards an area in the vicinity of the user's mouth and nose. The following step 54 includes delivering the oxygen gas in the vicinity of the user's mouth and nose.

### Usage Scenario

The portable oxygen delivery device can be carried by a user outside on highly urbanized/busy streets, on the way and in the office; even with user being in athletic activities; by a mobile user; used at home; used for stressful times, and of course to help user to alleviate a headache. The portable oxygen delivery device is designed to fit firmly high operational autonomy and mobility (water and sunlight can be freely found almost everywhere).

The portable oxygen delivery device is great for anyone who participates in mountain activities including; skiing, mountain climbing, off road or distance biking, rock climbing, trail running, and hiking. Travelers can also greatly benefit by using the portable auction delivery device. A possible application includes usage before and after air travel. Another application is stress removal. The portable oxygen delivery device 1 can be used at work to get the competitive edge and keep better focus. Further, no bacteria or virus can survive in an oxygen enriched environment which means that the portable oxygen delivery device can be used to minimize infection probability while commuting in densely populated areas (bus, tram, metro or other crowded areas).

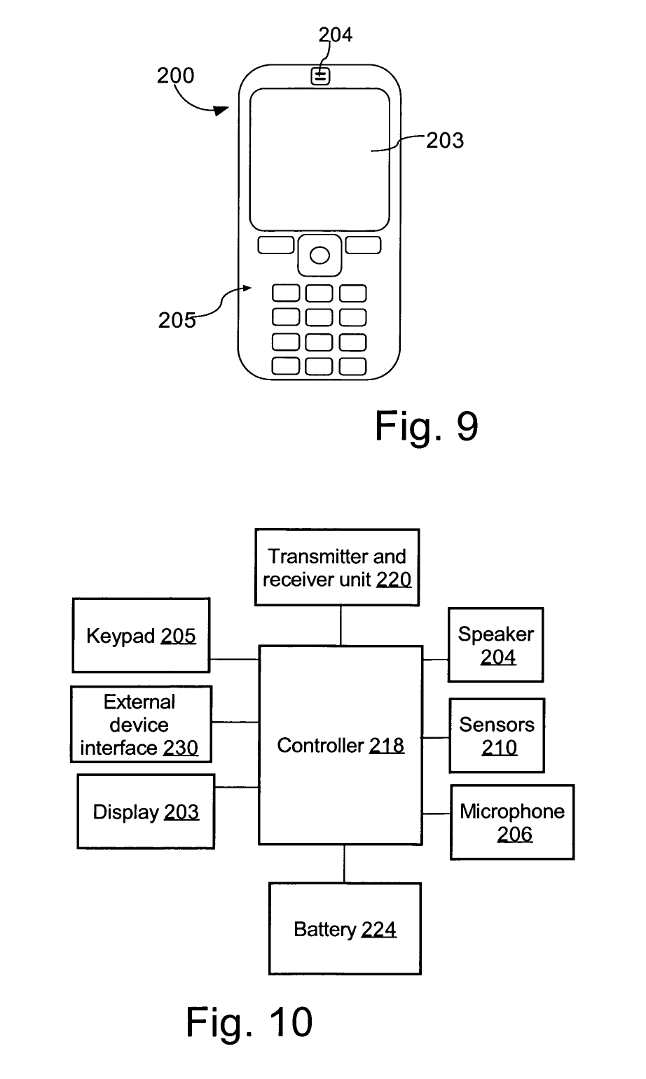

FIGS. 9 and 10 illustrate a mobile device according to an embodiment of the invention. The mobile device 200, in this embodiment a mobile phone, has a housing, a display 203, speaker 204 and a keypad 205. The operation of the mobile phone 200 is controlled by a controller 218. The controller is connected to the display 203, to the speaker 204, to the keypad 205, to the microphone 206, to a transmitter, to a receiver unit 220 and to a rechargeable battery 224. The mobile phone 200 further includes sensors 210 and an external device interface 230 that are both connected to the controller 218.

The external device interface 230 is suitable for interfacing with an external device like the portable oxygen delivery device 20. The external device interface 230 is suitable for controlling the operation of the external device that is connected to the mobile phone 200. The controller 218 is configured to control the operation on the external device when such an external device is connected to the mobile phone 200. In particular, controller 218 can be configured to control the operation of the portable oxygen delivery device, i.e. starting and stopping the electrolysis process in accordance with circumstances. The controller will take into account status of the mobile phone 200 and control the portable oxygen delivery device accordingly. In particular, the control can control the operation of the portable auction delivery device in accordance with receipt of a messages or a command string from a remote device or service. Such a service maybe located at a hospital, or maybe a server that monitors the data on air quality at the actual location of the mobile phone 200.

In an embodiment the mobile phone 200 is provided with sensors 210 that are connected to the controller 18. The sensors 210 deliver real-time signal to the controller 218. The real time measurements delivered by the sensors include one or more of: place (actual position), ambient air quality, ambient air pollution level, ambient air oxygen level, temperature, ambient air pressure, altitude, user heart rate and user breathing rate.

In response to this signal or these signals the controller 218 determines to start or stop the oxygen production process.

The external device interface 230 may in an embodiment also include a connection for establishing a circuit that directs current from the battery to a 24 in the mobile phone 200 to the external device. Thus, the mobile electric device 200 can be used to power the portable oxygen delivery device 20, and to recharge the rechargeable battery 23 in the portable oxygen delivery device.

Invention has been disclosed as integrated in a cap or vest, but it is understood that it could be integrated in any other garment that can be worn or carried by user.

The invention has numerous advantages. Different embodiments or implementations may yield one or more of the following advantages. It should be noted that this is not an exhaustive list and there may be other advantages which are not described herein. One advantage of the invention is that it allows for autonomous oxygen delivery. It is another advantage of the invention that it allows for an oxygen delivery system that is mobile and lightweight. It is also an advantage of the invention that it allows a for an oxygen delivery system that can be integrated into a garment. It is a further advantage of the invention that it allows for an oxygen delivery system that has low operational costs. It is further advantage of the invention that it allows for an environmental friendly oxygen delivery system. It is another advantage of the invention that it allows for achieve more satisfying health and wellbeing level of a user. It is a further advantage of the invention than it can support extensive activities including skiing, backpacking, and camping, hiking, mountain biking, cycling and climbing. Another advantage is provided by miniaturization possibility offered by the present invention since liquid is the source of the oxygen (18 grams of water contains 25 liters of gaseous oxygen at atmospheric pressure) which offers huge potential for miniaturized portable application concepts and improved safety regulations (oxygen generated/consumed on user demand not stored in heavy bottles in gaseous phase).

The term “comprising” as used in the claims does not exclude other elements or steps. The term “a” or “an” as used in the claims does not exclude a plurality.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon. Moreover, it should be appreciated that those skilled in the art, upon consideration of the present disclosure, may make modifications and/or improvements on the apparatus hereof and yet remain within the scope and spirit hereof as set forth in the following claims.

1-38. (canceled)

39. A device, comprising:
an energy source coupled to an electrolysis unit configured to split water into oxygen gas and hydrogen gas; and
an oxygen dispensing conduit coupled to said electrolysis unit, said conduit being configured to transport said oxygen gas produced to an area near the users nose and mouth and said conduit being configured to release said oxygen gas produced in said area near the users nose and mouth.

40. A device according to claim 39, wherein said energy source comprises at least one solar cell.

41. A device according to claim 40, wherein said at least one solar cell is integrated into a garment.

42. A device according to claim 40, wherein said at least one solar cell is flexible.

43. A device according to claim 40, further comprising at least one of a rechargeable battery and capacitor, wherein said at least one solar cell is configured for harvesting solar energy stored in said at least one of said capacitor and said battery and released on user demand.

44. A device according to claim 41, wherein said garment is one of a jacket, a vest, a cap a belt and a backpack.

45. A device according to claim 39, wherein said electrolysis unit comprises a water container with two gas receiving chambers.

46. A device according to claim 45, wherein each gas receiving chamber has at least one electrode.

47. A device according to claim 45, wherein said water container is an exchangeable cartridge.

48. A device according to claim 45, wherein said container is refillable.

49. A device according to claim 39, wherein said electrolysis unit is integrated into a garment.

50. A device according to claim 40, wherein said solar cells are connected to said at least one of said capacitor and said battery for charging said at least one of said battery and said capacitor.

51. A device according to claim 39, wherein said electrolysis unit is selectively connectable to at least one of said battery and said capacitor.

52. A device according to claim 39, further comprising an electrical connector for allowing at least one of said electrolysis unit, said battery and said capacitor to be connected to an external source of electrical power.

53. A device according to claim 39, wherein said dispensing conduit is connected to said outlet of the gas receiving chamber that contains one of the anodes of said electrodes.

54. A device according to claim 53, wherein a filter is disposed at said outlet.

55. A device according to claim 39, further comprising a gas flow regulator adapted to regulate the release of oxygen towards the user.

56. A device according to claim 39, further comprising an oxygen dispensing arm in an upstream portion of said dispensing conduit.

57. A device according to claim 56, wherein said oxygen dispensing arm is integrated into a body garment.

58. A device according to claim 56, wherein said dispensing arm is integrated into at least one of a cap and spectacles.

59. A device according to any of claim 39, wherein the dispensing conduit comprises flexible tubing between said electrolysis unit and said oxygen dispensing arm.

60. A device according to claim 45, further comprising a hydrogen gas release vent coupled to the gas receiving chamber that comprises one of the cathodes of said electrodes.

61. A, comprising:
providing a portable electrolysis device that is configured to split water into oxygen gas and hydrogen gas,
collecting said oxygen gas and transporting it towards an area in the vicinity of the users mouth and nose, and
delivering the oxygen gas in the vicinity of the users mouth and nose.

62. A mobile device comprising a controller, said mobile device being provided with an interface for connecting to a portable oxygen delivery device and said mobile device being configured for controlling the operation of a portable oxygen delivery device.
